(19) United States
(12) Patent Application Publication
(10) Pub. No.: US 2013/0208978 A1
(43) Pub. Date: Aug. 15, 2013

(54) CONTINUOUS CHARTING OF NON-UNIFORMITY SEVERITY FOR DETECTING VARIABILITY IN WEB-BASED MATERIALS

(71) Applicants: Evan J. Ribnick, St. Louis Park, MN (US); David L. Hofeldt, Oakdale, MN (US); Derek H. Justice, Cary, NC (US); Guillermo Sapiro, Durham, NC (US)

(72) Inventors: Evan J. Ribnick, St. Louis Park, MN (US); David L. Hofeldt, Oakdale, MN (US); Derek H. Justice, Cary, NC (US); Guillermo Sapiro, Durham, NC (US)

(73) Assignee: 3M INNOVATIVE PROPERTIES COMPANY, St. Paul, MN (US)

(21) Appl. No.: 13/876,871

(22) PCT Filed: Oct. 4, 2011
(86) PCT No.: PCT/US11/54673

§ 371 Date: Mar. 29, 2013

Related U.S. Application Data
(60) Provisional application No. 61/394,655, filed on Oct. 19, 2010.

(51) Int. Cl. G06K 9/66

(52) U.S. Cl. CPC G06K 9/66
USPC 382/159

(57) ABSTRACT

A computerized inspection system is described for detecting the presence of non-uniformity defects in a manufactured web material and for providing output indicative of a severity level of each defect. The system provides output that provides the severity levels of the non-uniformity defects in real-time on a continuous scale. Training software processes a plurality of training samples to generate a model, where each of the training samples need only be assigned one of a set of discrete rating labels for the non-uniformity defects. The training software generates the model to represent a continuous ranking of the training images, and the inspection system utilizes the model to compute the severity levels of the web material on a continuous scale in real-time without limiting the output to the discrete rating labels assigned to the training samples.

### CROSS REFERENCE TO RELATED APPLICATION

This application claims the benefit of U.S. Provisional Patent Application No. 61/394,655, filed Oct. 19, 2010, the disclosure of which is incorporated by reference herein in its entirety.

### TECHNICAL FIELD

The invention relates to automated inspection systems, such as computerized systems for inspection of moving webs.

### BACKGROUND

Computerized inspection systems for the analysis of moving web materials have proven critical to modern manufacturing operations. The goal of a production line is to produce material which is perfectly uniform and devoid of variability. However, non-uniformity is a common problem when manufacturing web-based materials. This can be caused by any number of process variables or formulation errors. Consequently, it is becoming increasingly common to deploy imaging-based inspection systems that can automatically classify the quality of a manufactured product based on digital images captured by optical inspection sensors (e.g., cameras). Some inspection systems apply algorithms, which are often referred to as “classifiers,” that attempt to assign a rating to each captured digital image (i.e., “sample”) indicating whether the sample, or portions thereof, is acceptable or unacceptable, in the simplest case.

These inspection systems often attempt to identify “point” defects in which each defect is localized to a single area of the manufactured material. However, other types of defects, referred to “non-uniform” defects or “non-uniformities” may exist in which the web material exhibits non-uniform variability over a large area. Examples of such non-uniformities include mottle, chatter, banding, and streaks. Non-uniformity-type defects such as these are by definition distributed and non-localized. As a result, such defects may be more difficult for computerized inspection systems to detect and quantify than localized, point defects. As a result, operators or quality control engineers may resort to inspecting sparsely sampled web samples manually offline, i.e., after production is finished.

### SUMMARY

In general, this disclosure describes a computerized inspection system for detecting the presence of non-uniformity defects and providing output indicative of a severity of each defect. Moreover, the techniques may provide output that provides a continuous charting of the non-uniformity severity. In other words, rather than being constrained to discrete rating labels, such as “acceptable” of “unacceptable,” or a “1,” “3,” or “5,” the computerized inspection system may provide a more continuous ranking of the samples. For example, the computerized inspection system may apply algorithms to produce a measurement of non-uniformity severity of a given sample on a continuous scale, such as 1.63 on a scale from 0 to 10.

In one embodiment, an apparatus comprises a processor and a memory storing a plurality of training samples. Each of the images has been assigned one of a set of discrete rating labels for a non-uniform defect present within the training images. Training software executing on the processor includes a feature extraction module to extract features from each of a plurality of training images by computing a feature vector for each of the training images from pixel values of the respective training image. The training software represents each of the feature vectors for the training images as a point within a multi-dimensional space. The training computes a continuous ranking of the training images in which each of the training images is assigned a non-uniformity severity ranking value on a continuous scale, for different types of defects.

In another embodiment, a computerized inspection system includes a memory to store a model that represents a continuous ranking of the training images as a plurality of points within a multidimensional feature space. Each of the points within the multidimensional space corresponds to a feature vector for a different one of the training images. The computerized inspection system includes a server executing software that processes a new image captured from a manufactured web material to extract features from the new image. The software computes a severity level of a non-uniform defect for the web material on a continuous scale based on the model of the training image. The computerized inspection system includes a user interface to output the severity level to a user.

In another embodiment, a method comprises executing software on a computer to extract features from each of a plurality of training images by computing a numerical descriptor for each of the training images from pixel values of the respective training image, wherein each of the images has been assigned one of a set of discrete rating labels for a non-uniform defect present within the training images. The method further comprises processing the numerical descriptors of the training images with the rating software to compute a continuous ranking of the training images based on the discrete rating labels assigned to the training images. The method includes processing a new image captured from a manufactured web material to extract features from the new image and compute a severity level of the non-uniform defect for the web based on the continuous ranking of the training image; and presenting a user interface to output the severity level to a user.

The techniques may provide one or more advantages. As one example, the more detailed the information provided to the operator, the more useful it can be in providing insight as to the cause of the non-uniformity. The continuous charting of the non-uniformity severity in which the severity level of a defect is output on a continuous scale in real-time may allow the operator to more clearly visualize the amount and severity of non-uniformity occurring over time, which may be more advantageous than discrete output such as “good” and “bad.” In this way, the output presented to the operator for a particular non-uniform defect is not constrained to the discrete rating labels assigned to the training samples.

In addition, the techniques may be applied by a computerized inspection system to provide real-time feedback to a user, such as a process engineer, within a web manufacturing facility regarding the presence of non-uniformities and their severity, thereby allowing the user to quickly respond to an emerging non-uniformity by adjusting process conditions to remedy the problem without significantly delaying production or producing large amounts of unusable material. In other words, application of the techniques may give the operator the ability to detect failures as they occur, reducing the amount of waste.

Further, the techniques may apply a continuous ranking model to achieve the continuous ranking of samples and, as input, the continuous ranking model may be developed from a set of training images for which non-uniformity severity levels are known only on a coarsely discretized scale, e.g., such as levels of “1,” “3,” and “5.”

Moreover, the techniques for continuous charting of non-uniformity severity described herein have applicability and usefulness in numerous product lines, including any material that is produced on a web. This technique is also useful in identifying and rating non-uniformities in products that are opaque or require reflective illumination. However, the techniques are not limited to any particular manufactured material or imaging modality.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example web manufacturing and conversion system in which the techniques described herein may be applied.

FIG. 2 is a block diagram illustrating an exemplary embodiment of an inspection system in an exemplary web manufacturing plant.

FIG. 3 is a flowchart illustrating an example operation of the systems described herein.

FIG. 4 illustrates a continuous three-dimensional (3D) surface, referred to as a “manifold,” in reference to which the algorithms applied by the training software to produce a continuous ranking model are readily understood.

FIG. 5 is a flowchart showing in more detail an example process by which training software processes feature vectors extracted from training images to develop a continuous ranking of the training images and produce a continuous ranking model.

FIG. 6 is a flowchart showing in more detail an example process by which a charting module utilize the continuous ranking model in real-time to detect the presence of non-uniformity defects and to provide a continuous charting of a severity level for each defect.

FIG. 7 is a graph providing a logical representation of finding the k-nearest neighbors in a 2-dimensional feature space.

FIG. 8 illustrates a second technique for finding the k-nearest neighbors using a hashing algorithm.

### DETAILED DESCRIPTION

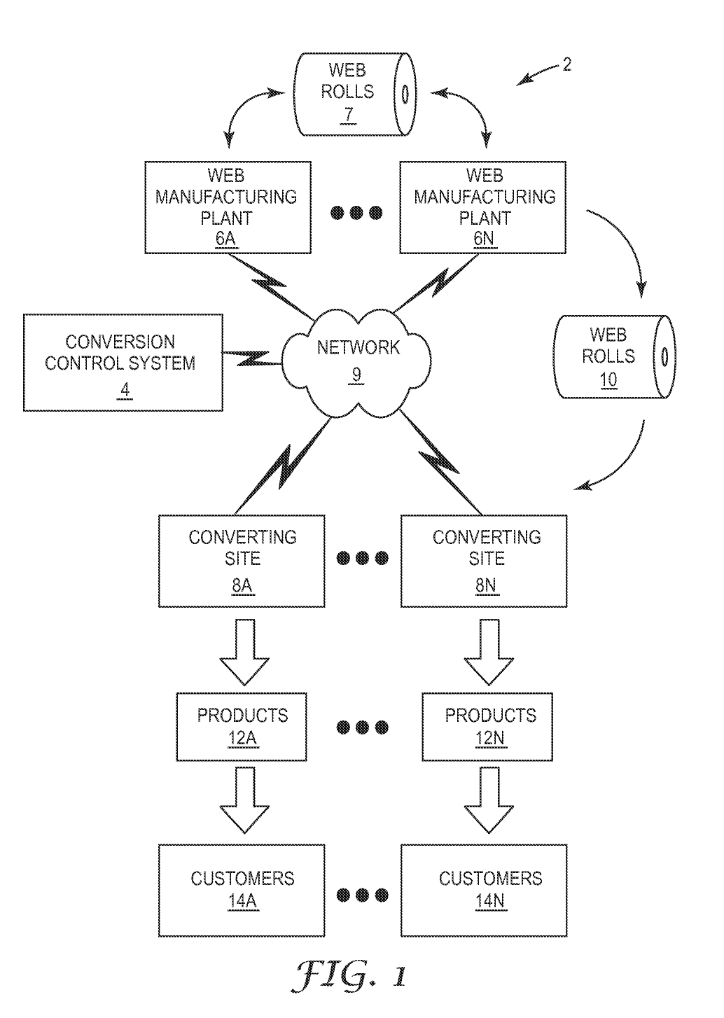

FIG. 1 is a block diagram illustrating an example system 2 in which the techniques described herein may be applied. Web manufacturing plants 6A-6N (web manufacturing plants 6) represent manufacturing sites that produce and ship web material in the form of web rolls 7. Web manufacturing plants 6 may be geographically distributed, and each of the web manufacturing plants may include one or more manufacturing process lines. In general, web rolls 7 may be manufactured by any of manufacturing plants 6 and shipped between the web manufacturing plants for additional processing. Finished web rolls 10 are shipped to converting sites 8A-8N (converting sites 8) for conversion into products 12A-12N (products 12). As shown in FIG. 1, conversion control system 4, web manufacturing plants 6A-6M (web manufacturing plants 6) and converting sites 8A-8N (converting sites 8) are interconnected by a computer network 9 for exchanging information (e.g., defect information) related to manufacture of the web material and conversion into products 12.

In general, web rolls 7, 10 may contain manufactured web material that may be any sheet-like material having a fixed dimension in one direction and either a predetermined or indeterminate length in the orthogonal direction. Examples of web materials include, but are not limited to, metals, paper, wovens, non-wovens, glass, polymeric films, flexible circuits or combinations thereof. Metals may include such materials as steel or aluminum. Wovens generally include various fabrics. Non-wovens include materials, such as paper, filter media, or insulating material. Films include, for example, clear and opaque polymeric films including laminates and coated films.

Converting sites 8 may receive finished web rolls 10 from web manufacturing plants 6 and convert finished web rolls 10 into individual sheets for incorporation into products 12 for sale to customers 14A-14N (customers 14). Converting systems may determine into which products 14 a given finished web roll 10 is converted based on a variety of criteria, such as grade levels associated with the product. That is, the selection process of which sheets should be incorporated into which products 12 may be based on the specific grade levels each sheet satisfies. In accordance with the techniques described herein, converting sites 8 may also receive data regarding anomalies, i.e. potential defects, in the finished web rolls 10. Ultimately, converting sites 8 may convert finished web rolls 10 into individual sheets which may be incorporated into products 12 for sale to customers 14A-14N (customers 14).

In order to produce a finished web roll 10 that is ready for conversion into individual sheets for incorporation into products 12, unfinished web rolls 7 may need to undergo processing from multiple process lines either within one web manufacturing plant, for instance, web manufacturing plant 6A, or within multiple manufacturing plants. For each process, a web roll is typically used as a source roll from which the web is fed into the manufacturing process. After each process, the web is typically collected again into a web roll 7 and moved to a different product line or shipped to a different manufacturing plant, where it is then unrolled, processed, and again collected into a roll. This process is repeated until ultimately a finished web roll 10 is produced. For many applications, the web materials for each of web rolls 7 may have numerous coatings applied at one or more production lines of one or more web manufacturing plants 6. The coating is generally applied to an exposed surface of either a base web material, in the case of the first manufacturing process, or a previously applied coating in the case of a subsequent manufacturing process. Examples of coatings include adhesives, hardcoats, low adhesion backside coatings, metalized coatings, neutral density coatings, electrically conductive or nonconductive coatings, or combinations thereof.

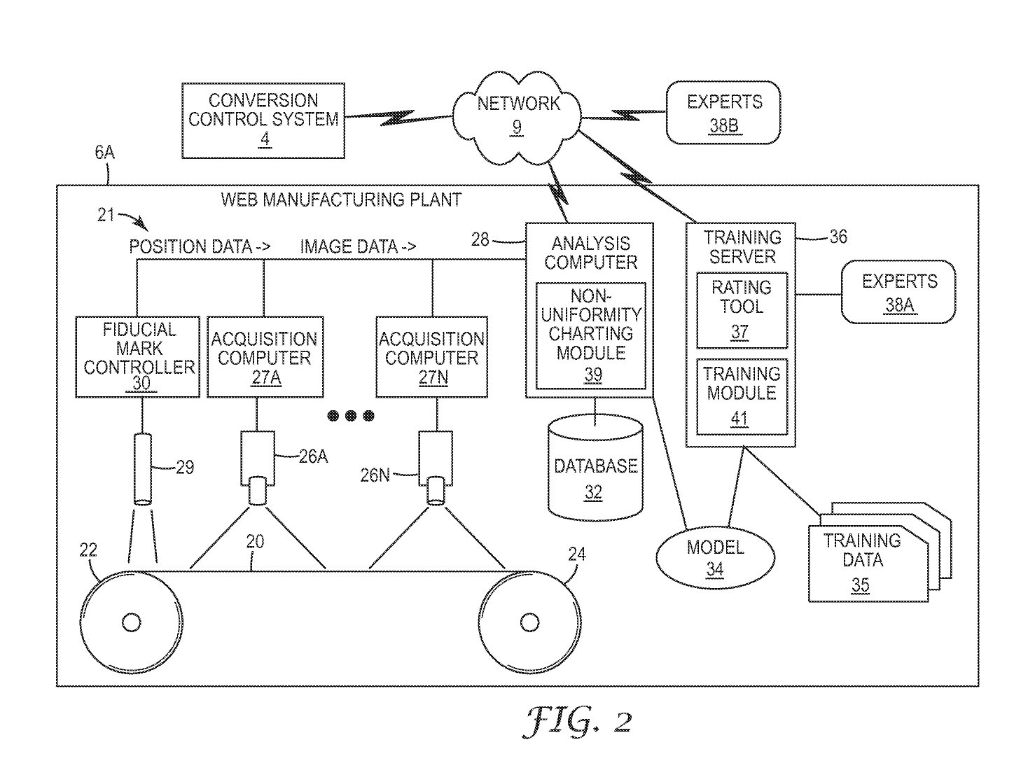

During each manufacturing process for a given one of web rolls 7, one or more inspection systems acquire anomaly information for the web. For example, as illustrated in FIG. 2, an inspection system for a production line may include one or more image acquisition devices positioned in close proximity to the continuously moving web as the web is processed, e.g., as one or more coatings are applied to the web. The image acquisition devices scan sequential portions of the continuously moving web to obtain digital images. The inspection systems include analysis computers that analyze the images with one or more algorithms to produce so-called “local” anomaly information that may represent an actual “defect” depending upon the ultimate product 12 into which the web is converted. The inspection systems may, for example, produce anomaly information for “point” defects in which each defect is localized to a single area. As another example, the inspections systems may produce anomaly information for “non-uniform” defects or “non-uniformities” in which the web material exhibits non-uniform variability over a large area larger than that of point defects. Examples of such non-uniformities include mottle, chatter, banding, and streaks.

The analysis computers within web manufacturing plants 6 may apply algorithms for detecting the presence of non-uniformity defects and providing output indicative of a severity of each defect. Moreover, the techniques may provide output that provides a continuous charting of the non-uniformity severity. The analysis computers may apply the algorithms in real-time as the web is manufactured or offline after all image data has been captured for the web. For example, the computerized inspection systems may provide real-time feedback to users, such as process engineers, within web manufacturing plants 6 regarding the presence of non-uniformities and their severity, thereby allowing the users to quickly respond to an emerging non-uniformity by adjusting process conditions to remedy the problem without significantly delaying production or producing large amounts of unusable material. The computerized inspection system may apply algorithms to produce a measurement of non-uniformity severity of a given sample on a continuous scale or more accurately sampled scale, such as 1.63 on a scale from 0 to 10. The continuous charting of the non-uniformity severity may allow the operator to more clearly visualize the amount and severity of non-uniformity occurring over time, which may be more advantageous than discrete output such as “good” and “bad.” For example, the computerized inspection system may provide detailed information to the operator that may lead to insight as to the cause of the non-uniformity.

During this continuous charting process, the analysis computers process the captured digital images by application of a continuous ranking model that has been developed based on training data. The training data is typically processed during a “training phase” of the algorithms and the continuous ranking model is developed to best match the training data. That is, after the training phase and development of the continuous ranking model, application of the continuous ranking model to the training data will label the training data with a high probability of correctness. Once the model has been developed from the training data, the analysis computers apply the model to samples captured from newly manufactured product, potentially in real-time, during the “classification phase” of the processing and provide a continuous charting of non-uniformity severity that is not constrained to discrete rating labels, such as “acceptable” of “unacceptable,” or a “1,” “3,” or “5,” the computerized inspection system may provide a continuous ranking of samples. For example, the computerized inspection system may apply algorithms to produce measurements of severity for non-uniformity defects within a web material on a continuous scale, such as 1.63 on a scale from 0 to 10. Moreover, the continuous ranking model used to achieve the continuous ranking of samples may be developed from a set of training images for which non-uniformity severity levels are known only on a coarsely discretized scale.

In some embodiments, analysis of digital images for a given manufactured web may be performed offline by conversion control system 4. Based on the classifications for a given web, conversion control system 4 may select and generate a conversion plan for each web roll 10. The analysis of the digital images and determination of the severity level may be application-specific in that a certain non-uniformity may result in a defect in one product, e.g., product 12A, whereas the anomaly may not cause a defect in a different product, e.g., product 12B. Each conversion plan represents defined instructions for processing a corresponding finished web roll 10 for creating products 12, which may ultimately be sold to customers 14. For example, a web roll 10 may be converted into final products, e.g., sheets of a certain size, for application to displays of notebook computers. As another example, the same web roll 10 may instead be converted into final products for application to displays of cell phones. Conversion control system 4 may identify which product best achieves certain parameters, such as a maximum utilization of the web, in view of the different defect detection algorithms that may be applied to the anomalies.

FIG. 2 is a block diagram illustrating an exemplary embodiment of an inspection system located within a portion of a web process line 21 in exemplary web manufacturing plant 6A of FIG. 1. In the exemplary embodiment, a segment of a web 20 is positioned between two support rolls 22, 24. Image acquisition devices 26A-26N (image acquisition devices 26) are positioned in close proximity to the continuously moving web 20 and scan sequential portions of the continuously moving web 20 to obtain image data. Acquisition computers 27 collect image data from image acquisition devices 26 and transmit the image data to analysis computer 28.

Image acquisition devices 26 may be conventional imaging devices that are capable of reading a sequential portion of the moving web 20 and providing output in the form of a digital data stream. As shown in FIG. 2, imaging devices 26 may be cameras that directly provide a digital data stream or an analog camera with an additional analog to digital converter. Other sensors, such as, for example, laser scanners, may be utilized as the imaging acquisition device. A sequential portion of the web indicates that the data is acquired by a succession of single lines. Single lines comprise an area of the continuously moving web that maps to a single row of sensor elements or pixels. Examples of devices suitable for acquiring the image include linescan cameras such as Piranha Models from Dalsa (Waterloo, Ontario, Canada), or Model Aviiva SC2 CL from Atmel (San Jose, Calif.). Additional examples include laser scanners from Surface Inspection Systems GmbH (Munich, Germany) in conjunction with an analog to digital converter.

The image data may be optionally acquired through the utilization of optic assemblies that assist in the procurement of the image. The assemblies may be either part of a camera, or may be separate from the camera. Optic assemblies utilize reflected light, transmitted light, or transflected light during the imaging process. Reflected light, for example, is often suitable for the detection of defects caused by web surface deformations, such as surface scratches.

In some embodiments, fiducial mark controller 30 controls fiducial mark reader 29 to collect roll and position information from web 20. For example, fiducial mark controller 30 may include one or more photo-optic sensors for reading bar codes or other indicia from web 20. In addition, fiducial mark controller 30 may receive position signals from one or more high-precision encoders engaged with web 20 and/or rollers 22, 24. Based on the position signals, fiducial mark controller 30 determines position information for each detected fiducial mark. Fiducial mark controller 30 communicates the roll and position information to analysis computer 28 for association with detected anomalies.

Analysis computer 28 processes streams of image data from acquisition computers 27. As one example, in accordance with the techniques described herein, computerized non-uniformity charting module 39 (“charting module 39”) executes on analysis computer 28 and applies algorithms that utilize continuous ranking model 34 (“model 34”) developed based on training data 35 to detect the presence of non-uniformity defects and provide a continuous charting of a severity level of each defect.

Training data 35 typically consists of a large set of representative sample digital images that have been assigned ratings by one or more experts 38. Previously automatically ranked data can be used for training as well. The digital images may, for example, represent samples taken from web 20 or another web previously produced by web process line 21. Training server 36 may provide an operating environment for execution of software that provides a computerized expert rating tool 37 (“rating tool 37”) to assist experts 38 in efficiently and consistently assigning ratings (i.e., labels) to the large collection of digital images representing the samples. Further details of an example expert rating tool 37 can be found in U.S. Provisional Patent Application No. 61/394,428, Ribnick et al., entitled “COMPUTER-AIDED ASSIGNMENT OF RATINGS TO DIGITAL SAMPLES OF A MANUFACTURED WEB PRODUCT,” filed Oct. 19, 2010.

Charting module 39 may be implemented, at least in part, as software instructions executed by one or more processors of analysis computer 28, including one or more hardware microprocessors, digital signal processors (DSPs), application specific integrated circuits (ASICs), field programmable gate arrays (FPGAs), or any other equivalent integrated or discrete logic circuitry, as well as any combinations of such components. The software instructions may be stored within in a non-transitory computer readable medium, such as random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. Although shown for purposes of example as positioned within manufacturing plant 6A, analysis computer 28 and charting module 39, as well as training server 36 and rating tool 37, may be located external to the manufacturing plant, e.g., at a central location or at a converting site. For example, analysis computer 28 and training server 36 may operate within conversion control system 4. In another example, charting module 39 and rating tool 37 execute on a single computing platform and may be integrated into the same software system.

Once training data 35 has been established, training module 41 processes the training data to generate continuous ranking model 34 for subsequent use by charting module 39 for real-time analysis of image data received from acquisition computers 27 for web material 20. In this way, new images of regions of web material 20 can be classified in accordance with continuous ranking model 34. Example defects that may be detected include non-uniformities such as mottle, chatter, banding, and streaks, as well as point defects including spots, scratches, and oil drips.

Analysis computer 28 stores the anomaly information for web 20, including roll identifying information for the web 20 and position information for each anomaly, within database 32. For example, analysis computer 28 may utilize position data produced by fiducial mark controller 30 to determine the spatial position or image region of each anomaly within the coordinate system of the process line. That is, based on the position data from fiducial mark controller 30, analysis computer 28 determines the x, y, and possibly z position or range for each anomaly within the coordinate system used by the current process line. For example, a coordinate system may be defined such that the x dimension represents a distance across web 20, a y dimension represents a distance along a length of the web, an the z dimension represents a height of the web, which may be based on the number of coatings, materials or other layers previously applied to the web. Moreover, an origin for the x, y, z coordinate system may be defined at a physical location within the process line, and is typically associated with an initial feed placement of the web 20. Database 32 may be implemented in any of a number of different forms including a data storage file or one or more database management systems (DBMS) executing on one or more database servers. The database management systems may be, for example, a relational (RDBMS), hierarchical (HDBMS), multidimensional (MDBMS), object oriented (ODBMS or OODBMS) or object relational (ORDBMS) database management system. As one example, database 32 is implemented as a relational database provided by SQL Server™ from Microsoft Corporation.

Once the process has ended, analysis computer 28 may transmit the data collected in database 32 to conversion control system 4 via network 9. For example, analysis computer 28 may communicate the roll information as well as the anomaly information and respective sub-images for each anomaly to conversion control system 4 for subsequent, offline, detailed analysis in accordance with continuous ranking model 34. For example, the information may be communicated by way of database synchronization between database 32 and conversion control system 4. In some embodiments, conversion control system 4 may determine those products of products 12 for which each anomaly may cause a defect, rather than analysis computer 28. Once data for the finished web roll 10 has been collected in database 32, the data may be communicated to converting sites 8 and/or used to mark anomalies on the web roll, either directly on the surface of the web with a removable or washable mark, or on a cover sheet that may be applied to the web before or during marking of anomalies on the web.

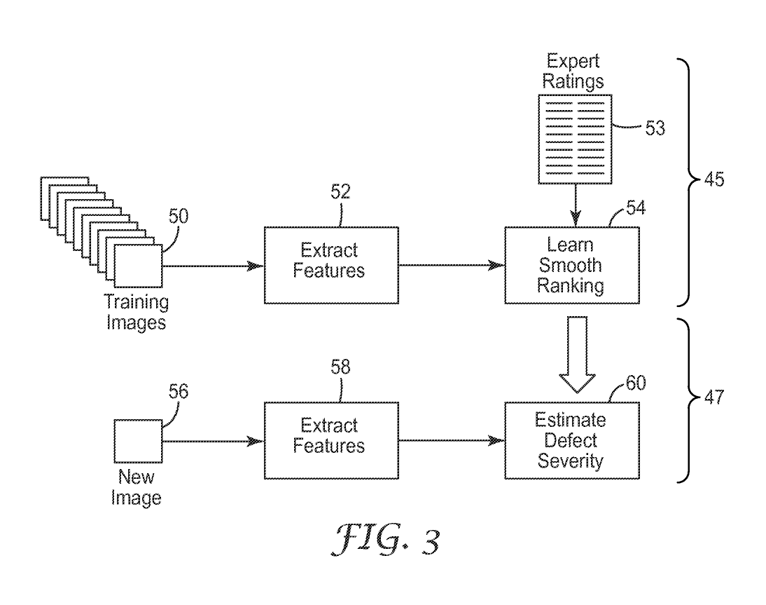

FIG. 3 is a flowchart that provides an overview of the operation of training module 41 and charting module 39. In general, the process comprises two general phases of processing: training phase 45 and online estimation phase 47.

Initially, training module 41 receives training data 35 as input, typically in the form of a set of images, for which severity rankings are already known on a possibly coarsely discretized scale (50). That is, training data 35 may be digital images representing samples taken from web 20, and computerized expert rating tool 37 (“rating tool 37”) may have assigned discrete ratings 53 to each of the digital images in the manner described by U.S. Provisional Patent Application No. 61/394,428.

Next, a feature extraction software module of training module 41 processes each of the images to extract features (52). Feature extraction provides a numerical descriptor of each of the images as a compact numerical representation of the relevant information inherent in each image. Features can be extracted in any way that preserves useful information about the relationships between images in the training set, and at the same time eliminates un-informative image characteristics. Examples of common feature extraction techniques include convolving the image with a set of filters and computing statistics of the filtered images, or extracting features based on color or intensity histograms. Sometimes the pixel values can be used as features, although in this case there is no compactness in the descriptor, since the entire image must typically be stored. In general, the resulting features are treated as compact descriptions of the relevant information in the corresponding images.

The techniques described herein are not limited to use with any particular feature extraction methodology, and may readily be applied to applications in which other types of features are more appropriate. In general, the features extracted from the images are descriptive in that they contain discriminating information about the images with respect to a particular type of non-uniformity. As such, once features have been extracted, the feature vector corresponding to each image represents most of the relevant information contained in that image.

One example way to encapsulate the relevant image information in a compact form, particularly as it relates to texture, is to compute a small covariance matrix of pixel features across the image. Once this small covariance matrix (e.g., 5×5) is extracted, pair-wise comparisons between images can be made efficiently based only on these matrices, instead of dealing with the images directly. For example, a grayscale image is defined as a two-dimensional array, indexed by pixel coordinates x and y, as I(x, y). At each pixel location (x, y), a feature vector is extracted based on the intensity values of the pixel and their first and second derivatives at that pixel:

$$f ( x , y ) = {( I ( x , y ) \frac{\partial I ( x , y )}{\partial x} \frac{\partial I ( x , y )}{\partial y} \frac{{\partial }^{2} I ( x , y )}{\partial {x}^{2}} \frac{{\partial }^{2} I ( x , y )}{\partial {y}^{2}} )}^{T} . \qquad ( 1 )$$

Image derivatives (gradients) can be approximated simply by computing forward or central differences between intensity values at each pixel. Other features, including higher derivatives or results from filtered image, can be incorporated in the vector in (eq. 1). Similarly, not all derivatives need to be included, e.g., if a derivative in a given direction provides no information for the particular defect, it can be removed from (eq. 1). Finally, the covariance matrix of these pixel features is computed across the entire image:

$${C}_{I} = \frac{1}{N - 1} {\sum }_{( x , y ) ∈ I} ( f ( x , y ) - μ ) {( f ( x , y ) - μ )}^{T} , \qquad ( 2 )$$

where N is the number of pixels in the image, and:

$$μ = \frac{1}{N} {\sum }_{( x , y ) ∈ I} f ( x , y ) \qquad ( 3 )$$

is the mean of the pixel features. In subsequent processing steps, it may be useful to compute pair-wise distances between images. In the case of these covariance matrix descriptors, pair-wise distances are computed as:

$${d}_{C} ( {I}_{1} , {I}_{2} ) = \sqrt{{\sum }_{i = 1}^{5} {ln}^{2} {λ}_{i} ( {C}_{{I}_{1}} , {C}_{{I}_{2}} ) ,} \qquad ( 4 )$$

where λᵢ(C_{I1};C_{I2}) is the ith generalized eigenvalue of the two covariance matrices. Further details can be found in O. Tuzel, F. Porikli, and P. Meer. “Region Covariance: A Fast Descriptor for Detection and Classification.” Proceedings of the European Conference on Computer Vision, 2006.

After extracting features for each of the training images, training module 41 process the feature vectors to learn a continuous ranking of the training images and produce continuous ranking model 34 based on the severity of their non-uniformities (54). During training phase 45, training module 41 learns a continuous ranking of the training images based on the severity of their non-uniformities. Initially, all that is known about each training image is the expert rating, denoting if the corresponding sample is “good” or “bad,” or a “1,” “3,” or “5” with respect to a particular type of non-uniformity. These expert ratings provide an often coarse ordering of the training images, i.e., the training images can be ranked into 2 or 3 discrete categories, or more categories if the operator is able to provide such information. Training model 41 uses this coarse ordering as input and learns a continuous ranking in which the training images are ranked from best to worst along a continuous scale with respect to a particular non-uniformity. Although a good ranking should heed the expert ratings as much as possible, for example assigning “good” images lower severity ranking than those labeled “bad,” in some instances training module 41 is not completely prevented from violating the coarse ranking implied by the discrete labels, since it is possible, and indeed common, that there are mistakes in the expert ratings due to the subjectivity of manual labeling of the training data.

During the online estimation phase 47, charting module 39 applies the learned continuous ranking model 34 in real-time on the production line. As a new image of the web being produced is captured (56), features are extracted in the same way as for the training images (58). Then, using continuous ranking model 34 from training phase 45, the new image is assigned a severity rating based on structured comparisons with the training images (60).

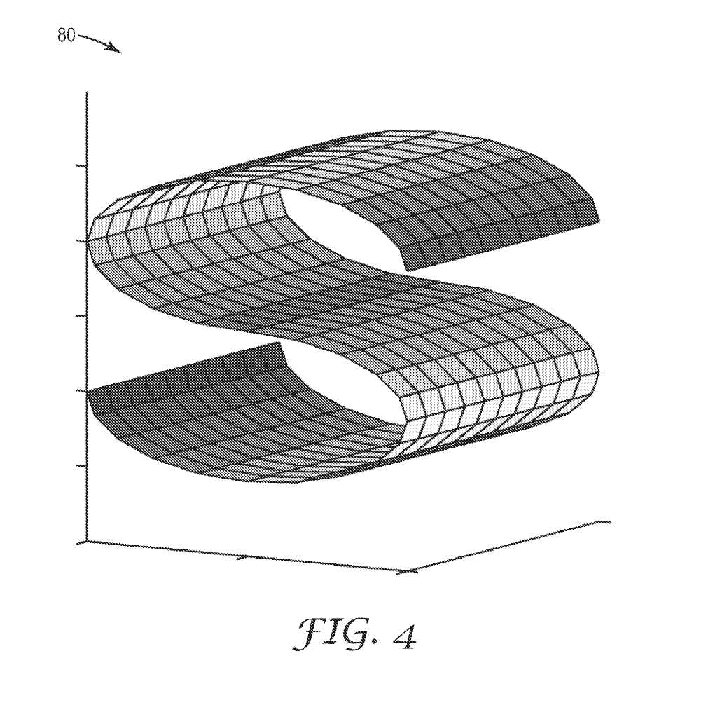

FIG. 4 illustrates a continuous three-dimensional (3D) surface, referred to as a “manifold” 80, in reference to which the algorithms applied by training module 41 to produce continuous ranking model 34 are readily understood. The feature vector associated with each image can be thought of as a single point in a high-dimensional space. However, since all of the images are of the same type of material and are taken with the same imaging device or other sensor, under the same imaging conditions and geometry, the underlying number of degrees of freedom can be lower than the dimensionality of the embedding feature space. It is therefore useful to view each training image as one of the high-dimensional points lying on manifold 80 (i.e., the continuous 3D surface), or a collection of manifolds, which is embedded in this space, but which may have a lower intrinsic dimensionality (degrees of freedom) than the overall space. An illustrative example is shown in FIG. 4 for the simple case of a 3-dimensional space with a 2-dimensional object embedded in it, although in practice the dimensionality of the feature vectors is typically much higher. Further example details on manifold embeddings in high-dimensional spaces are described in H. S. Seung and Daniel D. Lee, “Cognition: The Manifold Ways of Perception,” Science, vol. 290, no. 5500, pp. 2268-2269, Dec. 22, 2000.

As one simple example with respect to FIG. 4, a set of training images in which all of the training images show the same web material with different levels of down-web chatter. In this simple case, even though each training image may be represented by a high-dimensional feature vector that captures various texture-related characteristics, in this case there may be only one underlying degree of freedom within this set of images, corresponding to the level of chatter. As such, these training images can be viewed as points that lie on a one-dimensional manifold, e.g., a line that snakes through a curvy path in the high-dimensional space of FIG. 4.

One advantage of this representation of feature vectors as points on a manifold is that the algorithms of training module 41 exploit this underlying structure in the training data in order to make use of only the most relevant and useful information contained therein. Moreover, the embedding in lower-dimensional spaces can be useful when learning from relatively few high-dimensional feature vectors. Algorithms exist for performing manifold embedding, which is the term used herein for the task of recovering low-dimensional representations of high-dimensional data while preserving the underlying structure. Some examples of such algorithms include Self-Organizing (Kohonen) Maps, Multi-Dimensional Scaling, Isomap, and Locally-Linear Embedding. One example algorithm is Diffusion Maps, as described in further detail below. Further details on Diffusion Maps can be found in S. Lafon and A. B. Lee, “Diffusion Maps and Coarse-Graining: A Unified Framework for Dimensionality Reduction, Graph Partitioning, and Data Set Parameterization, IEEE Transactions on Pattern Analysis and Machine Intelligence, vol. 28, no. 9, pp. 1393-1403, September 2006.

Given the representation of each training image as a point on a manifold in feature space, the algorithms of training module 41 perform a discrete random walk around the feature space. During this random walk, for each time step, the random walker can move from one point on the manifold to another, without ever leaving the manifold. In this context, the algorithms compute the probability of transitioning from a point on the manifold to all other points. In general, this transition probability is typically higher for nearby points in the manifold and lower for distant points. However, the algorithms take into consideration the expert ratings, penalizing for transitions between points with different discrete labels. These transition probabilities are then used to propagate the expert ratings from each point to all the surrounding points, so that every point ends up with some fraction of the discrete labels from the other points, which allows us to compute a continuous severity value for each point corresponding to one of the training images along the continuous surface. Both the extracted features and the provided (expert) rankings are exploited at this stage.

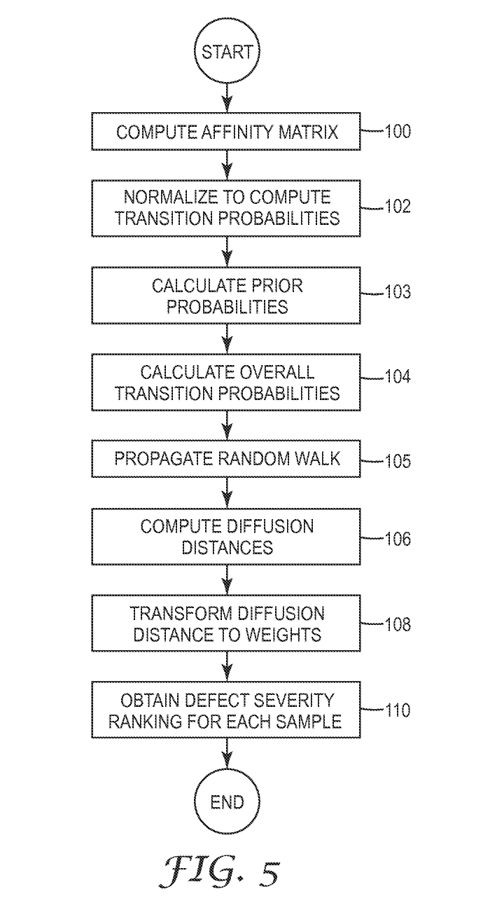

FIG. 5 is a flowchart showing in more detail an example process by which training module 41 processes the feature vectors to learn a continuous ranking of the training images and produce continuous ranking model 34.

First, training module 41 computes an affinity matrix K of size N-by-N, where N is the number of training samples (step 100). For example, to learn a continuous ranking of the N training images, the set of feature vectors are defined as x₁, x₂, . . . , x_{N}, with corresponding expert ratings C₁, C₂, . . . , C_{N}. Each discrete rating is assumed as either a “1,” “3,” or “5,” i.e., cᵢε{1, 3, 5}, where a “1” is a sample that is acceptable, and a “5” is a sample that is clearly unacceptable. The expert ratings can be either more or less finely discretized than this, and the algorithms are not limited to this particular example. Given the feature vectors, training module 41 computes the affinity matrix K of size N-by-N, where each element can be given, for example, by

k(i,j)=exp(−∥xᵢ−xⱼ∥²/σ²). (5)

The affinity matrix gives a measure of similarity between each pair of training samples in feature space, and others different than (eq. 5) can be used, e.g., polynomial ones. The bandwidth parameter σ defines how quickly the exponential decays as the distance between a pair of points increases. In practice, a local parameter σ is estimated for each training sample according to a heuristic, such as the median distance to its k-nearest neighbors. In this case, the denominator of Equation (5) becomes the product of the local bandwidths corresponding to samples xᵢ and xⱼ.

The distance used in the affinity matrix can be simply the Euclidean distance as in the example in (5) or more sophisticated ones, depending on the features, such as covariance distances or Kullback-Leibler distances.

Next, from the affinity matrix, the transition probabilities can be calculated (step 102) according to:

pₐ(i,j)=k(i,j)/Σₗk(i,l), (6)

which corresponds to the probability of transitioning from xᵢ to xⱼ on a random walk in feature space, based only on the affinities between points. This is a normalization of the affinity matrix K, which ensures that its rows are valid probability distributions (i.e., sum to one).

In order to take the discrete labels given by the expert ratings into account, training module 41 compute the prior probabilities of transitioning from xᵢ to xⱼ

p_{b}(i,j)=exp(−|cᵢ−cⱼ|²/σₚ²), (7)

where σₚ is a bandwidth parameter for this prior probability term (step 103). The expression for p_{b}(i,j) penalizes more heavily for expert ratings that are farther part, so that the choice of the numerical values assigned to discrete labels is important in this context.

Training module 41 then computes the overall transition probability for each pair of training samples by the product of pₐ(i,j) and p_{b}(i,j) (in step 104),

p(i,j)=pₐ(i,j)p_{b}(i,j). (8)

The components of the automatic diffusion matrix and the penalty for violating expert ratings may be combined in other ways. Collectively, the overall transition probabilities p(i,j) form the matrix P. Each entry in P represents the probability of transitioning between the corresponding pair of points in one time step.

Training module 41 propagates the random walk transition probabilities for t time steps by raising the matrix P to the power t (step 105)

Pₜ=P^{t}, (9)

where Pₜ(i,j) corresponds to the probability of transitioning from xᵢ to xⱼ in t time steps. The number of time steps t has no physical meaning, but is a configurable parameter that can be set in the software application by the user.

Based on these transition probabilities, training module 41 computes diffusion distances (step 106). Each such distance is a measure of dissimilarity between each pair of points on the manifold. Two points are assigned a lower diffusion distance (i.e., are said to be closer together in diffusion space) if their distributions of transition probabilities are similar. In other words, if their respective rows of the matrix Pₜ are similar to one another, the two points are assigned a lower diffusion distance. In one example, the squared diffusion distances are computed according to the equivalent expression:

d²(i,j)=Σₗλₗ^{2t}(ψₗ(i)−ψₗ(j))², (10)

where Pψₗ=λₗ, i.e., ψₗ and λₗ are the eigenvectors and eigenvalues of P, respectively. This may avoid the use of resources associated with explicitly raising the matrix P to the power t, which can be a computationally expensive operation if numerous training samples are available. Fast techniques for computing eigenvectors can be used, in particular those developed to compute the first eigenvectors corresponding to the largest eigenvalues.

These diffusion distances, which are proportional to the dissimilarity between pairs of samples, are converted by training module 41 to weights (step 108) that are proportional to the similarities according to:

w(i,j)=exp(−d²(i,j)/σ_{w}²)/η, (11)

where σ_{w} is another bandwidth parameter, and η is simply a normalization constant which ensures that rows of the weight matrix W sum to one. Finally, training module 41 generates continuous ranking model 34 (“model 34”) by computing the non-uniformity severity ranking value for each of the training samples xᵢ (step 110) by:

rᵢ=Σⱼw(i,j)cⱼ. (12)

The resulting ranking value rᵢ is a weighted average of the Expert Ratings of all the training images. However, even though the expert ratings may be highly discrete (e.g., “1”, “3”, or “5”), the ranking values are on a continuous fine scale. Furthermore, the algorithm parameters can be adjusted by a user interface so as to give a ranking which is continuous overall. The weights in (eq. 12) are derived by the diffusion distance process that combines automatic image/feature comparisons with expert rankings. Other ways of normalized weighting can be considered, e.g., exponential weighting functions.

The process described above with respect to FIG. 5 can override incorrect labels in the expert ratings. That is, if the expert had mistakenly labeled a certain image as, for example, a “1” instead of a “5,” the process could still assign this point a ranking value closer to the other “5” points. This is primarily due to the influence of the two different terms in the product of Equation (8). While the second term takes the discrete labels into account, the first term is based only on the intrinsic structure of the data on the manifold. The relative effects of these terms are controlled by their respective bandwidth parameters. If σₚ is set to a large value, then the prior probability term will have very little influence on the transition probabilities.

Further, multiple experts can be combined as well. In this case, training module 41 utilizes an additional weight on the computation of the affinity matrix for each one of the experts. Reliability of the different experts can be assessed in the same fashion.

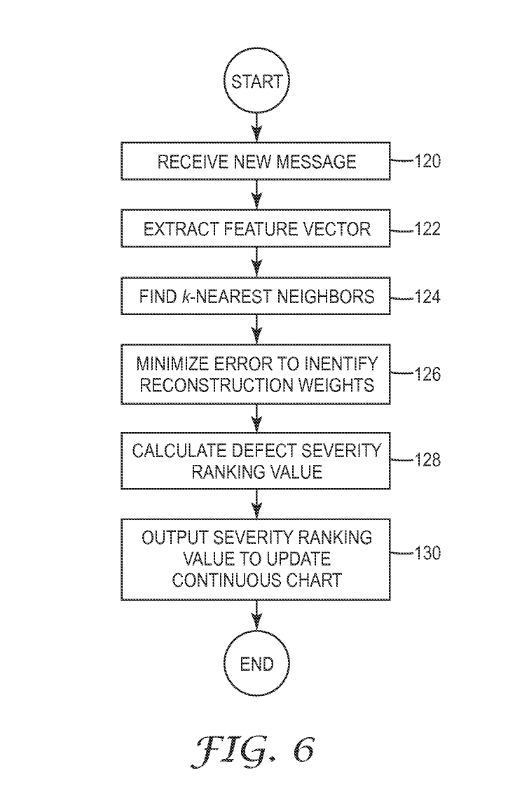

FIG. 6 is a flowchart showing in more detail an example process by which charting module 39 utilize continuous ranking model 34 (“model 34”) in real-time to detect the presence of non-uniformity defects and to provide a continuous charting of a severity level for each defect.

As a new image of the web being produced is captured (120), features are extracted in the same way as for the training images (122). Specifically, given the feature vectors of the training samples x₁, x₂, . . . , x_{N}, along with corresponding ranking values learned in the training phase r₁, r₂, . . . , r_{N}, the function of the real-time charting module 39 is to estimate the ranking value for a new feature vector x_{q} extracted from the new image, which is referred to herein as the query sample.

Initially, charting module 39 locates the k-Nearest Neighbors of x_{q} among the training samples x₁, x₂, . . . , x_{N} for a given defect (124). In one embodiment, charting module 39 uses the Euclidean distance in feature space to find the nearest neighbors, given by

dᵢ=∥x_{q}−xᵢ∥₂. (13)

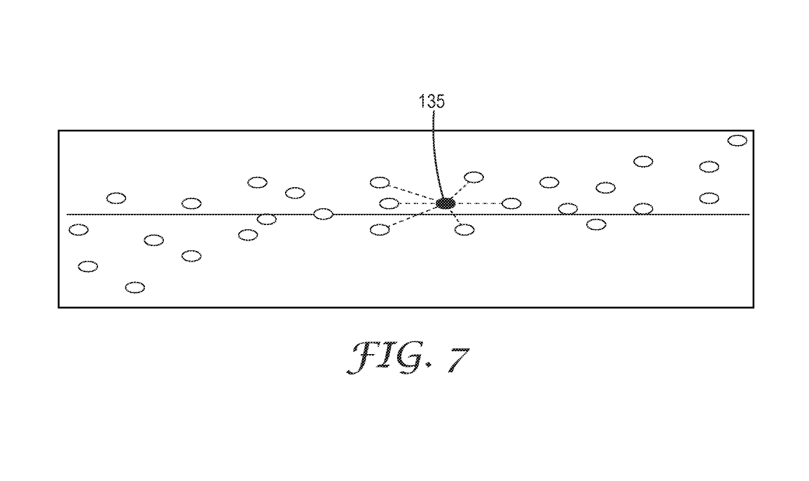

Charting module 39 may present an interface by which the user is able to specify the number of nearest neighbors, k, as a configurable parameter. FIG. 7 is a graph providing a logical representation of finding the k-nearest neighbors in a 2-dimensional feature space. In this example, six nearest neighbors are identified for query point 135 within the feature space.

Several techniques may be used to locate the k-nearest neighbors. One technique is to perform an exhaustive search by computing the distance from x_{q} (the query point) to each sample x₁, x₂, . . . , x_{N} in the training set. However, this type of exhaustive search can be computationally expensive, especially if the number of training samples is large and the feature space is high dimensional. Two other techniques are described. One is an exact search, i.e., the technique returns the same results as an exhaustive search but in a more efficient manner, and the other an approximate search. Both techniques provide significant improvement in terms of computational overhead in comparison to the exhaustive search. Any k-nearest neighbor search methods can be used, these just represent two examples.

One technique for performing a more efficient k-Nearest Neighbors (kNN) search, but which still gives the same results as the exhaustive search, is to first organize the training samples x₁, x₂, . . . , x_{N} into a “ball tree.” The ball tree is a data structure which organizes the training samples into hierarchical groupings based on their proximity in feature space. At the lowest level of the tree, each “leaf” node will contain one or several samples which are close together. As charting module 39 progresses higher up the tree, the groupings contain larger numbers of points, but still grouped based on proximity. Finally, at the top of the tree, the “root” node contains all points in this training set. Note that this structured is computed only once for the training samples, and then will be used multiple times for the queries. Further details on use of a ball tree are described in A. W. Moore, “The Anchors Hierarchy: Using the Triangle Inequality to Survive High Dimensional Data,” Proceedings of the 12^{th} Conference on Uncertainty in Artificial Intelligence, pp. 397-405, 2000.

Once the training samples are organized in this hierarchical ball tree, they can be searched efficiently to find exactly the kNNs of a new query point. The algorithm for performing this search can be recursive, and exploits the intrinsic structure of the training data in order to search it efficiently. For example, if it is known that the query point x_{q} is close to one particular node in the ball tree, then charting module 39 does not waste time to continue searching for the kNNs of the query point in another node far away. The computational price for this increased efficiency at search time is in the complexity of building the tree, which contains only the training samples and can thus be constructed offline.

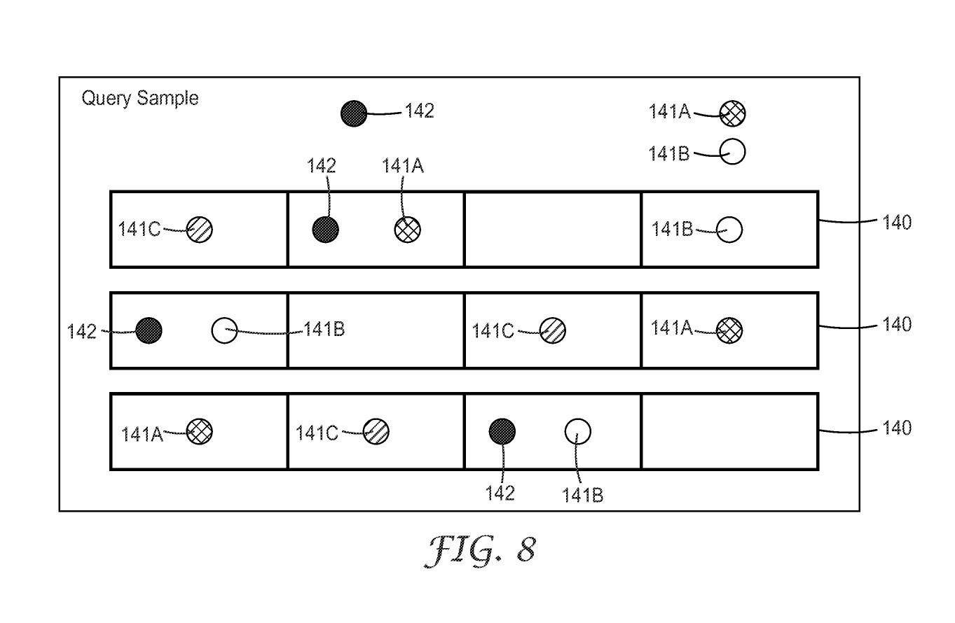

As a second example, further computational efficiency can be achieved by using approximate kNN searches, which are designed to give results close to those of the exhaustive search, although they are not guaranteed to be exactly the same. One such approach is Locality-Sensitive Hashing (LSH). As before, charting module 39 organizes the training samples based on their structure in feature space in order to enable rapid kNN search. In this case, several hash tables are formed that index the training samples. Each hash table is formed by taking a random projection of the training samples, resulting in a one-dimensional representation for each sample, and then binning the samples along this line into a set of discrete groups. Repeating this procedure, several hash tables are formed and the approximate kNNs of a point can be quickly found with high probability based on these hash tables. An illustration of this is shown in FIG. 8, for the simple case of three hash tables 140 into which each of the three training samples 141A, 141B and 141C and the query sample 142 are hashed. In this case, indexing the resulting hash tables results in correctly identifying the two nearest-neighbors 141A, 141B of the query sample. Further details on Locality-Sensitive Hashing (LSH) are described in “Locality-sensitive hashing: A. Andoni and P. Indyk, \Near-Optimal Hashing Algorithms for Approximate Nearest Neighbor in High Dimensions,” Communications of the ACM, vol. 51, no. 1, pp. 117-122, January 2008.

Returning to the flowchart of FIG. 6, after identifying the k-Nearest Neighbors, charting module 39 computes the reconstruction weights for the query point that best express the query point as a linear combination of its k-nearest neighbors (126). The weights can be either positive or negative, and can be computed by minimizing the following error:

ε=∥x_{q}−Σ_{iεΩ}wᵢwᵢ∥₂, (14)

where the wᵢ's are the reconstruction weights, and Ω is the set of k-nearest neighbors. The error function (14) can be minimized in closed form. The weights can also be computed in a closed form.

Next, charting module 39 computes the severity ranking value of the query point for the particular defect as the weighted average of the ranking values of its k-nearest neighbors for that defect (128). In one example, the severity ranking value can be calculated as:

r_{q}=Σ_{iεΩ}wᵢrᵢ, (15)

As before, the non-uniformity severity ranking value of the query point is on a continuous scale. This approach allows the query point to receive a ranking value that is close to those of the most similar images in the training set. It is contemplated that other out-of-sample techniques can be used instead of the nearest-neighborhood technique.

Finally, charting module 39 outputs the computed severity ranking value to the operator (130). The output may take the form of updating a chart so as to show a trend in the severity ranking for the defect, or charting module 39 may simply output the severity ranking value as a single number. For example, charting module 39 may update a chart upon processing each new image so as to graph the severity level of the non-uniform defect for the web material over time. The computerized inspection system or other component may subsequently receive input from the user specifying a change to a process control parameter for the manufacturing process, and may adjust the process control parameter in response to the input.

Various embodiments of the invention have been described. These and other embodiments are within the scope of the following claims.

1. A method comprising:
executing software on a computer to extract features from each of a plurality of training images by computing a numerical descriptor for each of the training images from pixel values of the respective training image, wherein each of the images has been assigned one of a set of discrete rating labels for a non-uniform defect present within the training images;
processing the numerical descriptors of the training images with the rating software to compute a continuous ranking of the training images based on the discrete rating labels assigned to the training images; and
processing a new image captured from a manufactured web material to extract features from the new image and compute a severity level of the non-uniform defect for the web based on the continuous ranking of the training image.

2. The method of claim 1, further comprising presenting a user interface to output the severity level to a user.

3. The method of claim 2, wherein presenting a user interface comprising updating a chart to graph the severity level of the non-uniform defect for the web material over time.

4. The method of claim 2, further comprising:
receiving input from the user; and
adjusting a process control parameter for the manufactured web material in response to the input.

5. The method of claim 1, wherein computing a numerical descriptor for each of the training images comprises computing a feature vector within a multi-dimensional feature space.

6. The method of claim 5, wherein processing the numerical descriptors of the training images with the rating software to compute a continuous ranking of the training images comprises:
representing each of the feature vectors for the training images as a point within the multi-dimensional space;
computing a transition probability from each point within the multi-dimensional space to each of the other points represented by the feature vectors, wherein computing the transition probabilities includes including a penalty for transitioning between two points that represent training images assigned different rating labels;
based on the transition probabilities, computing pair-wise distances between each of the points, wherein each of the distances indicate a measure of dissimilarity between the training images represented by the points; and
computing a non-uniformity severity ranking for each of the training images as a function of the pair-wise distances between the point represented by the training image and each of the other points with the multidimensional feature space.

7. The method of claim 6, wherein processing a new image comprises:
computing a feature vector within a multi-dimensional feature space for the new image;
identifying, with the software, a plurality of nearest neighboring points for the training image in the multi-dimensional feature space;
computing a set of reconstruction weights that best express the feature vector for the new image as a linear combination of the plurality of nearest neighboring points; and
computing the severity level of the non-uniform defect of the new image based on a weighted average of the non-uniformity ranking values of the training images represented by the plurality of nearest neighboring points within the multidimensional space.

8. An apparatus comprising:
a processor;
a memory storing a plurality of training samples, wherein each of the images has been assigned one of a set of discrete rating labels for a non-uniform defect present within the training images; and
training software executing on the processor, wherein the software includes a feature extraction module to extract features from each of a plurality of training images by computing a feature vector for each of the training images from pixel values of the respective training image,
wherein the training software represents each of the feature vectors for the training images as a point within a multi-dimensional space, and computes a continuous ranking of the training images in which each of the training images is assigned a non-uniformity severity ranking value on a continuous scale.

9. The apparatus of claim 8, wherein the training software computes a transition probability from each point within the multi-dimensional space to each of the other points represented by the feature vectors, wherein the training software includes a penalty in the transition probabilities that correspond to transitions between two points that represent training images assigned different rating labels.

10. The apparatus of claim 8, wherein the training software computes pair-wise distances between each of the points based on the transition probabilities, wherein each of the distances indicate a measure of dissimilarity between the training images represented by the points; and
computes the non-uniformity severity ranking value for each of the training images as a function of the pair-wise distances between the point represented by the training image and each of the other points with the multidimensional feature space.

11. A computerized inspection system comprising:
a memory to store a model that represents a continuous ranking of the training images as a plurality of points within a multidimensional feature space; wherein each of the points within the multidimensional space corresponds to a feature vector for a different one of the training images;
a server executing software, wherein the software processes a new image captured from a manufactured web material to extract features from the new image and compute a severity level of a non-uniform defect for the web material continuous scale based on the model of the training image; and
a user interface to output the severity level to a user.

12. The computerized inspection system of claim 11, wherein the software computes a feature vector within a multi-dimensional feature space for the new image, identifies a plurality of nearest neighboring points within a multi-dimensional feature space having a plurality of points, computes a set of reconstruction weights that best express the feature vector for the new image as a linear combination of the plurality of nearest neighboring points, and computes the severity level of the non-uniform defect for the web based on a weighted average of the non-uniformity ranking values of the training images represented by the plurality of nearest neighboring points within the multidimensional space.

13. A non-transitory computer-readable medium comprising software instructions to cause a computer processor to:
execute software on a computer to extract features from each of a plurality of training images by computing a numerical descriptor for each of the training images from pixel values of the respective training image, wherein each of the images has been assigned one of a set of discrete rating labels for a non-uniform defect present within the training images;
process the numerical descriptors of the training images with the rating software to compute a continuous ranking of the training images based on the discrete rating labels assigned to the training images;
process a new image captured from a manufactured web material to extract features from the new image and compute a severity level of the non-uniform defect for the web based on the continuous ranking of the training image; and
present a user interface to output the severity level to a user.
